(19) United States
(12) Patent Application Publication
(10) Pub. No.: US 2002/0152890 A1
(43) Pub. Date: Oct. 24, 2002

(54) Electrically enhanced air filter with coated ground electrode

(76) Inventor: Randal D. Leiser, Middleton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/841,212

(22) Filed: Apr. 24, 2001

(51) Int. Cl. B03C 3/00

(52) U.S. Cl. 95/63

(57) ABSTRACT

An electrostatically stimulated air filtering device includes a dielectric filter material having an inlet side and an opposed outlet side for filtering out contaminants in an air stream directed through the device. A grounded control electrode is positioned upstream of the filter material, and an ionizer electrode is positioned between the control electrode and the filter material. A flexible ground electrode is positioned downstream of the filter material, the ground electrode being comprised of an electrically conductive painted coating confined to and in planar contact with the outlet side of the filter material.

### FIELD OF THE INVENTION

This invention relates generally to electrically enhanced air filtration apparatus having an upstream control electrode, an ionizer electrode, a pleated, dielectric filter material and a downstream ground electrode, and more particularly, pertains to improvements in the downstream ground electrode thereof.

### BACKGROUND OF THE INVENTION

One type of well known electrically enhanced air filtration system is set forth in Jaisinghani U.S. Pat. No. 5,403,383 issued Apr. 4, 1995, and commonly assigned to the assignee of this application. In the '383 patent, there is disclosed an electrically enhanced filtering device comprising a housing having an air intake and an air exhaust, an upstream control electrode disposed downstream of the air intake for carrying a ground potential, filter material disposed downstream of the upstream control electrode for filtering out contaminants in the air, an ionizer electrode disposed between the filter material and the upstream control electrode for carrying a second potential, a downstream ground electrode disposed downstream of the filter material for carrying a ground potential and a fan upstream of the filter material for driving air through the filter material. Ionization of incoming air occurs as a result of the electric fields generated between the downstream ground electrode, the ionizer electrode, and the upstream control electrode. Contaminants in the air are given a positive charge and are captured in the filter material. The filter material comprises an upstream dielectric layer with a downstream conductive layer, such as, for example, fibers coated with activated carbon powder. The downstream conductive layer is in electrical contact with the downstream ground electrode.

In the preferred embodiment of the Jaisinghani patent, the upstream control electrode and downstream ground electrode are comprised of a metal screen or grid of slit and expanded metal material. The ground electrode must be in direct contact with the downstream side of the filter material to electrically ground the filter material. The patent also discloses the use of pleated filter material over two inches in depth for which the use of supplemental, composite filter material incorporating relatively conductive material is necessary. This relatively conductive material is described as glass or plastic fiber material coated with carbon or other conductive material rendering the relatively conductive material considerably more electrically conductive than the dielectric layer of material.

Several drawbacks have been uncovered in the use of the Jaisinghani filtering device. As noted above, the prior art required a separate ground electrode in the form of a metal screen to be placed in direct contact with the filter material. This requirement necessitated the use of a bonding means, such as adhesive, to maintain the intimate contact. The difficulty with this construction is achieving and maintaining contact between the filter material and the metal ground electrode. The pleat tip heights of the filter material vary due to the pleating process which further exasperates the control problems. Attachment of the separate ground electrode must be done after the filter is assembled so that the filter must be shipped in an expanded state within a rigid framework. A further difficulty encountered is that the metal ground electrode adds air flow resistance to the filter which is an undesirable effect. Also as previously described, the prior art filtering device requires a composite filter material of conductive material which extends into the filter towards the ionizing wires. If this coating extends inwardly too close to the ionizing wires, arcing from the wires toward the filter could occur causing failure of the unit.

Accordingly, there is a need for a different style or form of ground electrode which overcomes the deficiencies discussed above.

### SUMMARY OF THE INVENTION

The present invention advantageously involves changing the ground electrode of the electrically enhanced air filter from a rigid, metal screen to an integral, flexible, electrically conductive coating which is strategically applied only to the downstream or exhaust side of the filter material.

It is a general object of the present invention to provide an electrically enhanced filtering device having an improved ground electrode.

It is also an object of the present invention to provide a ground electrode which is an integral part of the filter material.

It is another object of the present invention to provide a ground electrode which does not add significant air flow resistance in the filter material.

It is a further object of the present invention to provide a ground electrode which allows the filter material to be shipped in a collapsed state.

It is an additional object of the present invention to provide a ground electrode in the form of a stripe of conductive material coated only on the tips of the exhaust side of the filter material.

Yet a further object of the present invention is to provide an electronic air filter having fewer parts and less material.

In one aspect of the invention, an electrically enhanced filtering device includes a dielectric filter material having an inlet side and an outlet side for filtering out contaminants in an air stream directed through the device. A grounded control electrode is positioned upstream of the filter material, and an ionizer electrode is positioned between the control electrode and the filter material. A flexible ground electrode is positioned downstream of the filter material, the ground electrode being comprised of an electrically conductive, painted coating confined to and in planar contact with the outlet side of the filter material. The ground electrode is substantially non-resistive to air stream flow through the filter material. The filter material has a collapsible and expandable state, and the coating is applied in liquid form while the filter material is in the collapsible state and dried while in the expandable state. The filter material is a pleated construction having upstream tips and opposed downstream tips, the coating being applied only to the downstream tips. The coating is comprised of preferably silver and copper particles suspended in the solvent carrier of substantially acrylic latex. The coating is preferably sprayed on the downstream tips. An inner housing for holding the filter material is provided with a movable end panel having a conductive rubber strip which is attached by clips, and is engagable with the conductive coating on the filter material. An outer housing is provided for slidably receiving the inner housing, the outer housing having a door with an electrically grounded metal interior engagable with the clips connected to the conductive rubber strip.

In another aspect of the invention, an electronic air filter has a dielectric filter material for trapping contaminants in an air stream drawn through the filter, a ground electrode positioned downstream of the filter material, an ionizer electrode positioned upstream of the filter material and a grounded control electrode positioned upstream of the ionizer electrode. The invention is improved wherein the ground electrode is constructed and arranged in the form of a conductive coating applied exclusively to downstream tips of the filter material to define a flexible, substantially planar, continuous surface integrally attached to the filter material, and the filter material is uncoated internally relative to the downstream tips thereof.

In yet another aspect of the invention, an electrically enhanced filtering device includes a dielectric filter material having an inlet side and an opposed outlet side for filtering out contaminants in an air stream directed through the device. The filter material is associated with a grounded control electrode positioned upstream thereof, an ionizer electrode positioned between the filter material and the control electrode, and a flexible, ground electrode positioned downstream of the filter material. The ground electrode is comprised of electrically conductive coating confined to and in planar contact with only the outlet side of the filter material. An inner housing is provided for holding the filter material, the inner housing having a conductive member engagable with the conductive coating on the filter material. An outer housing is also provided for slidably receiving the inner housing, the outer housing having a grounded member engagable with the conductive member on the inner housing.

In yet a further aspect of the invention, there is provided a method of filtering out contaminants in a moving air stream. The method comprises the steps of providing a filter having an upstream side and a downstream side for filtering out the contaminants passing in the air stream; providing a grounded control electrode positioned upstream of the filter; providing an ionizer electrode positioned between the control electrode and the filter; and providing a flexible, ground electrode positioned downstream of the filter, the ground electrode being comprised of an electrically conductive coating confined to and in planar contact with the downstream side of the filter. The filter is a pleated construction having upstream tips and downstream tips, the filter having a collapsible state and an expandable state. The step of providing the ground electrode includes compressing the filter into its collapsible state; spray painting the downstream tips only of the filter with the conductive coating; and bringing the filter to its expandable state to allow the conductive coating to dry with the downstream tips being held spaced apart.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a schematical, cross-sectional view of a filter and electrode portion for an electrostatically stimulated filtering device according to the present invention;

FIG. 1A is a detail view taken on line 1-1 of FIG. 1;

FIG. 2A is a diagrammatic view showing the filter material coated with the ground electrode of the present invention in a collapsed state;

FIG. 2B is a diagrammatic view showing the coated filter material in a finished, expanded state;

FIG. 3 is a representation of the coating of the ground electrode on a pleated tip of the filter material;

FIG. 4 is a perspective view of an inner housing assembly for the filter material coated with the ground electrode;

FIG. 5 is a partial sectional view taken on line 5-5 of FIG. 4 showing the pleated coated tips of the filter material held separated by a spacer; and

FIG. 6 is a perspective, exploded view of the inner housing assembly of FIG. 4 slidably received in an outer housing, and a door which is removably attached to the end of the outer housing.

### DETAILED DESCRIPTION OF THE EMBODIMENT

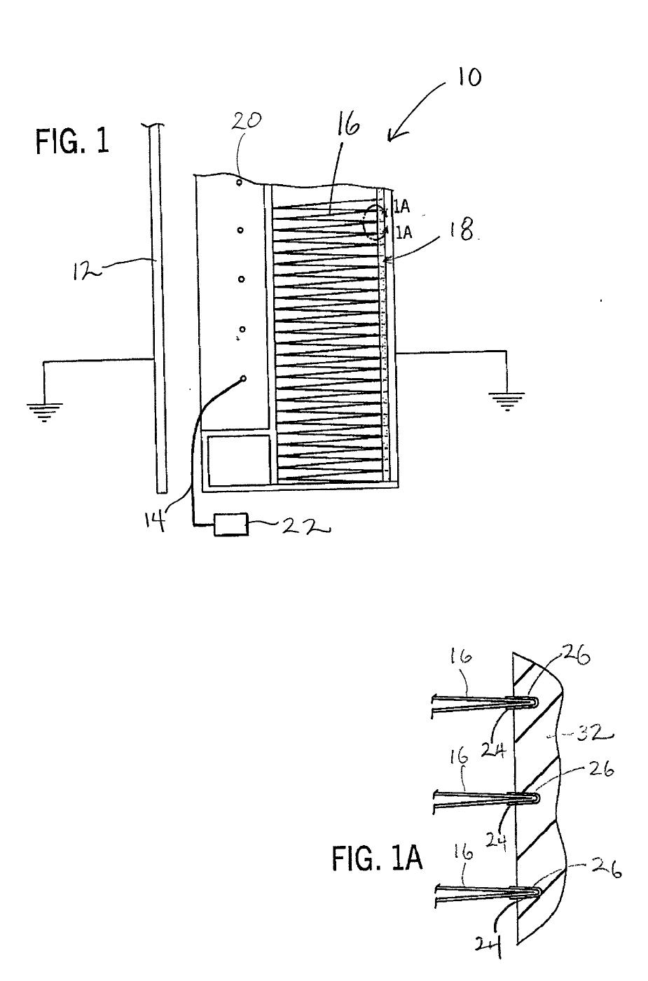

Referring now to the drawings, FIG. 1 illustrates a filter and electrode portion 10 of an electrically enhanced filtering device or electronic air cleaner including an upstream, grounded control electrode 12, an ionizer electrode 14, a pleated, dielectric, collapsible filter material 16 of glass or plastic fiber (preferably not exceeding two inches in depth) and a downstream ground electrode 18 embodying the present invention. The ionizer electrode 14 incorporates ionizing wires 20 which are energized by a high voltage, direct current supply 22.

The ionizer electrode 14 is maintained at a higher potential than the control electrode 12 and ground electrode 18. Ionization of contaminants entering the air cleaner occurs in the charged area around the ionizer electrode 14 between the control electrode 12 and the ground electrode 18. The contaminants are given a positive charge and are captured in the filter material 16 which is grounded by the ground electrode 18.

In accordance with the present invention, the ground electrode 18, in contrast with the prior art separate, rigid grid of slit and expanded material, takes the form of a coating of conductive material applied integrally only to the tips of the pleated filter material 16 on its downstream or exhaust side. None of the conductive coating can extend inwardly beyond the pleated tips of the filter material 16. Were the coating to extend into the filter material 16 and approach the ionizing wires 20, arcing from the wires 20 towards the filter material 16 could occur causing failure of the air cleaner.

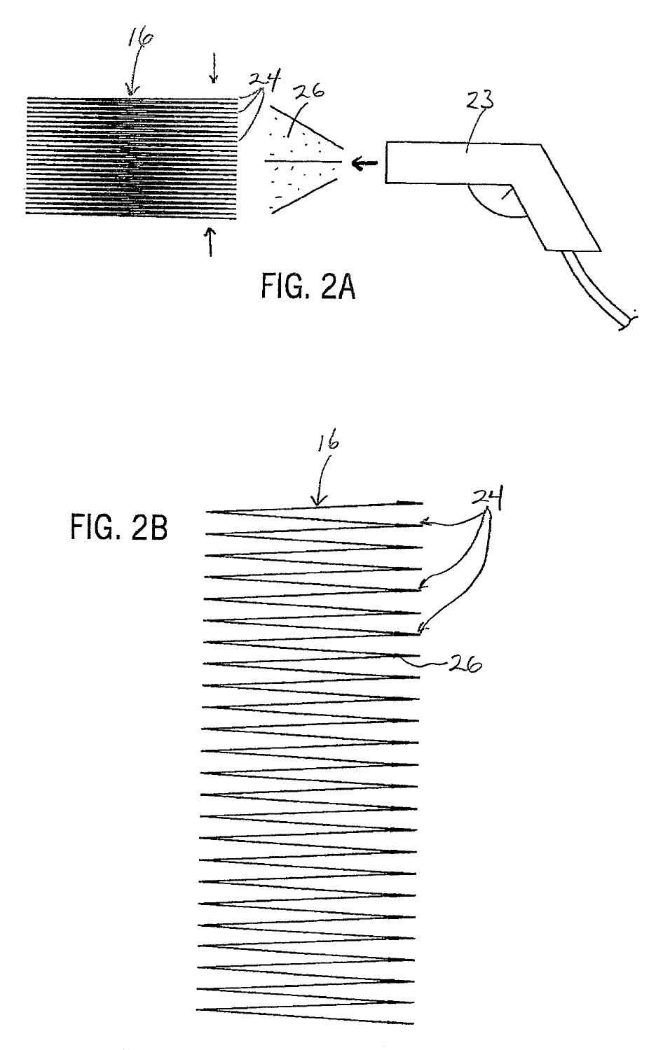

Referring now to FIGS. 1A, 2A and 2B, application of the conductive coating to form the ground electrode 18 can be done by various methods, including, but not limited to brushing, rolling, spraying, or dipping. The coating method desired in the preferred embodiment is to collapse the pleated filter material 16 (as shown in FIG. 2A), and with a gun 23, spray the pleated tips 24 on the exhaust side with conductive silver and copper particles 26 suspended in a wet solvent carrier comprised substantially of acrylic latex. Fixtures are used to mask all surfaces of the filter material 16 except the pleated tips 24. The filter material 16 is then held in the expanded position (shown in FIG. 2B) while the coating dries so that the pleated tips 24 do not stick together. The coating on each tip 24 must have electrical continuity. The preferred embodiment requires a resistance of no greater than 7.5 ohms per inch measured along the pleat.

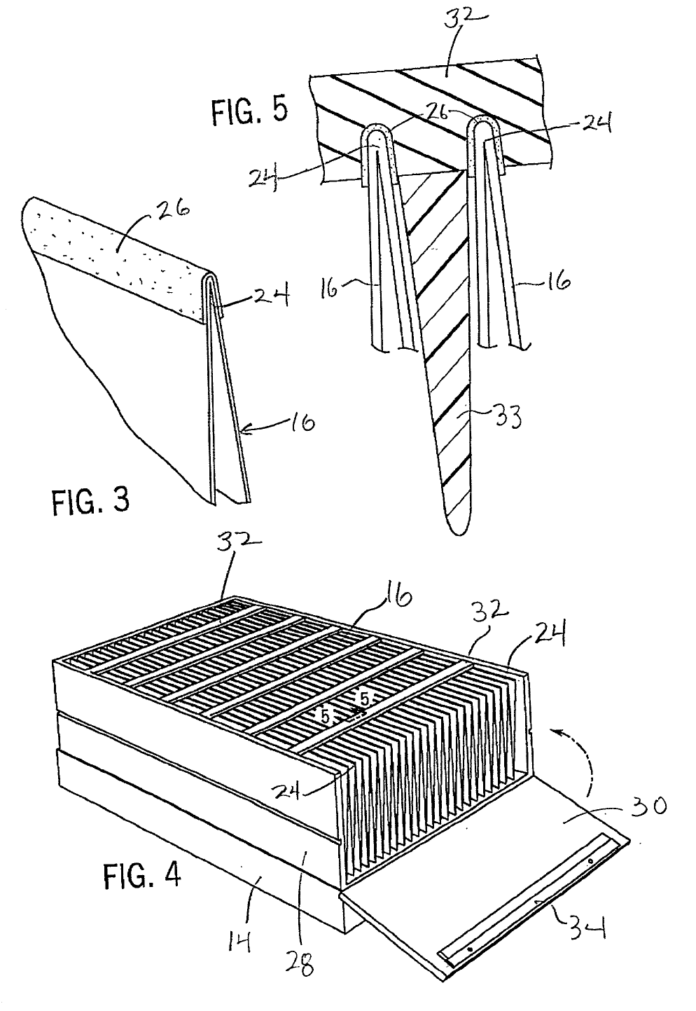

The coated, pleated tips 24 (FIG. 3) which now define the ground electrode 18, must be connected to electrical ground. FIG. 4 shows ionizer electrode 14 and an inner housing assembly 28 with an end panel 30 for enclosing the filter material 16 with the conductive coating on the pleated tips 24. The pleated tips 24 are held separated by a series of plastic spacers 32, each having a depending tip 33 (FIG. 5). A conductive rubber strip 34 is attached to the end panel 30 which, when a door 36 (FIG. 36) is closed, makes contact with the conductive coating on the pleated tips 24.

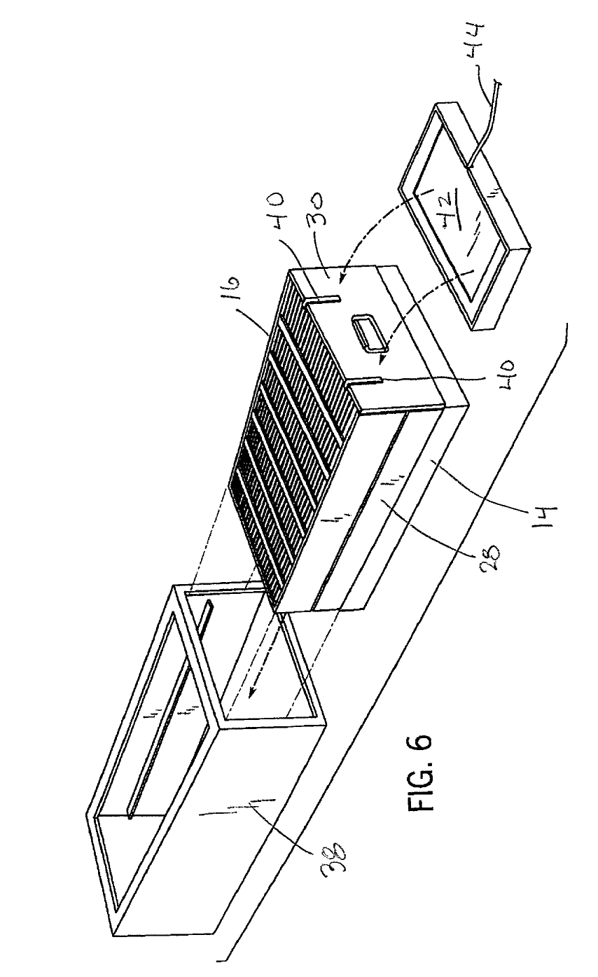

FIG. 6 shows a disassembled arrangement of the major components of the electronic air cleaner wherein the ionizer electrode 14 and the inner housing assembly 28 of FIG. 4 are slidably inserted into an outer housing 38. Spring steel clips attach to the conductive rubber strip 34 inside the inner housing assembly 28. When the door 36 of the cleaner is closed, the metal interior 42 of the door 36 contacts the clips 40 and completes the path to earth ground through a grounded electrical cord 44.

The present invention thus provides an electronic air cleaner with a flexible ground electrode which is an integral part of the filter material and which does not have to be glued to the filter material as part of the rigid framework. As a result, the flexible ground electrode does not add significant air flow resistance and permits the filter material to be shipped in a collapsed state providing significant savings and shipping costs. Also, there is no need to supplementally coat the inside of the filter material which further saves manufacturing time and expense, and reduces the risk of unsafe arcing from occurring. Further costs are realized by coating only the downstream tips of the filter material.

While the invention has been described with reference to a preferred embodiment, those skilled in the art will appreciate that certain substitutions, alterations and the omissions may be made without departing from the spirit thereof. Accordingly, the foregoing description is meant to be exemplary only and should not be deemed limitative on the scope of the invention set forth in the following claims.

I claim:

1. An electrically enhanced air filtering device comprising:
a dielectric filter material having an inlet side and an outlet side for filtering out contaminants in an air stream directed through the device;
a grounded control electrode positioned upstream of the filter material;
an ionizer electrode positioned between the control electrode and the filter material; and
a flexible ground electrode positioned downstream of the filter material, the ground electrode being comprised of an electrically conductive painted coating confined to and in planar contact with the outlet side of the filter material.

2. The filtering device of claim 1, wherein the ground electrode is substantially non-resistive to air stream flow through the filter material.

3. The filtering device of claim 1, wherein the filter material has a collapsible and expandable state, and the coating is applied in liquid form while the filter material is in the collapsible state and dried while in the expandable state.

4. The filtering device of claim 1, wherein the filter material is a pleated construction having upstream tips and opposed downstream tips, the coating being applied only to the downstream tips.

5. The filtering device of claim 1, wherein the coating is comprised of silver and copper particles suspended in a solvent carrier of substantially acrylic latex.

6. The filtering device of claim 4, wherein the coating is sprayed on the downstream tips.

7. The filtering device of claim 1, including an inner housing for holding the filter material provided with a movable end panel having a conductive rubber strip which is attached by clips and is engagable with the conductive coating on the filter material.

8. The filtering device of claim 7, further including an outer housing for slidably receiving the inner housing, the outer housing having a door with an electrically grounded metal interior engagable with the clips connected to the conductive rubber strip.

9. In an electronic air cleaner having a dielectric filter material for entrapping contaminants in an air stream drawn through the filter material, a ground electrode positioned downstream of the filter material, an ionizer electrode positioned upstream of the filter material and a grounded control electrode positioned upstream of the ionizer electrode, the improvement wherein:
the ground electrode is constructed and arranged in the form of a conductive coating applied exclusively to downstream tips of the filter material to define a flexible, substantially planar, continuous surface integrally attached to the filter material, and
the filter material is uncoated internally relative to the downstream tips thereof.

10. An electrically enhanced filtering device comprising:
a dielectric filter material having an inlet side and an opposed outlet side for filtering out contaminants in an air stream directed through the device, the filter material being associated with a grounded control electrode positioned upstream thereof, an ionizer electrode positioned between the filter material and the control electrode, and a flexible ground electrode positioned downstream of the filter material, the ground electrode being comprised of electrically conductive coating confined to and in planar contact with only the outlet side of the filter material;
an inner housing for holding filter material, the inner housing having a conductive member engagable with the conductive coating on the filter material; and
an outer housing for slidably receiving the inner housing, the outer housing having a grounded member engagable with the conductive member on the inner housing.

11. A method of filtering out contaminants in a moving air stream, the method comprising the steps of:
providing a filter having an upstream side and a downstream side for filtering out the contaminants passing in the air stream;
providing a grounded control electrode positioned upstream of the filter;
providing an ionizer electrode positioned between the control electrode and the filter; and
providing a flexible ground electrode positioned downstream of the filter, the ground electrode being comprised of an electrically conductive coating confined to and in planar contact with the downstream side of the filter.

12. The method of claim 11, wherein the filter is a pleated construction having upstream tips and downstream tips, the filter having a collapsible state and an expandable state.

13. The method of claim 12, wherein the step of providing the ground electrode includes
compressing the filter into the collapsible state;
spray painting the downstream tips only of the filter with the conductive coating; and
bringing the filter to its expandable state to allow the conductive coating to dry with the downstream tips held spaced apart.
